(19) United States
(12) Patent Application Publication
(10) Pub. No.: US 2002/0055289 A1
(43) Pub. Date: May 9, 2002

(54) Wire connecting connector

(75) Inventors: Takao Murakami, Shizuoka-ken (JP); Masaru Fukuda, Shizuoka-ken (JP)

Correspondence Address: Finnegan, Henderson, Farabow,, Garrett & Dunner, L.L.P., 1300 I Street, N.W., Washington, DC, 20005-3315, US

(73) Assignee: Yazaki Corporation

(21) Appl. No.: 09/986,112

(22) Filed: Nov. 7, 2001

(30) Foreign Application Priority Data
Nov. 8, 2000 (JP) P 2000-340261

(51) Int. Cl. H01R 3/08

(52) U.S. Cl. 439/178

(57) ABSTRACT

One terminal having a pair of first contacts (15a and 15b) projects from a bottom (14a) of a receptor (14). Another terminal (16) having a pair of second contacts (16a and 16b) corresponding to the first contacts (15a and 15b) projects from a tip end of an inserting body (13). A partition wall (18) for insulating the first contacts (15a) and (15b) from each other is provided in the receptor (14). A groove (19) into which the partition wall (18) can be inserted is formed in a tip end of the insertion body (13). A conductive gel (20) is charged into the receptor (14) so as to bury the first contacts (15a and 15b), and an insulative gel (21) is overlaid on an outer side of the conductive gel (20).

### BACKGROUND OF THE INVENTION

1. Field of the Invention

The present invention relates to a wire connecting connector for connecting an electric wire.

2. Description of the Related Art

An ignition coil 1 shown in FIG. 1 which applies spark voltage to an ignition plug of an engine is mounted to an engine body and then an ignition cable is connected to the ignition coil 1. The ignition cable is connected to a distributor and is further connected to the ignition plug through the distributor.

The proposed ignition cable is connected to the ignition coil 1 through a wire connecting connector 2 comprising a male connector 3 shown in FIG. 2 and a female connector 4 shown in FIG. 3. The male connector 3 integrally projects from a head of the ignition coil 1 which accommodates an igniter 1a, and one terminal 5 projects within a cylindrical receptor 3a. On the other hand, the female connector 4 comprises a housing 4a to be fitted over an outer periphery of the receptor 3a, an inserting body 4b which is provided in the housing 4a and to be fitted into an inner periphery of the receptor 3a, and a crimping terminal 6 as another terminal which is accommodated in the inserting body 4b. The ignition cable 7 extending from the distributor is connected to the crimping terminal 6.

After the ignition coil 1 is mounted to the engine body, and when the female connector 4 is inserted into the male connector 3, the inserting body 4b and the receptor 3a are fitted to each other and the one terminal 5 is inserted into the crimping terminal 6 to establish an electrical connection therebetween. At that time, a fluid-tight function between the inserting body 4b and the receptor 3a is secured by a packing 8 provided on the outer periphery of the inserting body 4b, and a fluid-tight function of an accommodating portion of the crimping terminal 6 is secured by a rubber stopper 8a provided on an introducing portion of the ignition cable 7. A retaining projection 3b which projects from a tip end of the receptor 3a engages a recess 4c of the housing 4a, thus preventing the disengagement therebetween.

According to the above-described wire connecting connector 2, however, in order to electrically connect the terminals reliably with each other, a resilient contact piece 9 is accommodated in the crimping terminal 6, and the one terminal 5 is inserted into the crimping terminal 6 while compressing the resilient contact piece 9. Thus, since the female connector 4 is inserted into the male connector 3 against the sliding friction force between the resilient contact piece 9 and an inner wall of the contact portion, a fitting load of the wire connecting connector 2 is increased, which deteriorates the connecting operability.

Since the packing 8 and the rubber stopper 8a are provided in order to obtain resistance to water of the contact portion between the terminals of the wire connecting connector 2, the number of parts constituting the wire connecting connector 2 is increased, thus complicating a structure of the connector, and the assembling operability of these members is deteriorated, which increase the costs of the wire connecting connector 2.

Furthermore, the disengagement prevention mechanism is provided with the retaining projection 3b and the recess 4c to ensure the reliable contacting performance between the terminals. In this case, however, it is necessary that a distance A between a bottom of the receptor 3a and the retaining projection 3b coincides with a distance B between a tip end of the inserting body 4b and the recess 4c and, at the same time, it is necessary that a projecting amount C of the one terminal 5 coincides with an insertion amount D of the terminal 5 into the crimping terminal 6 while compressing the compression spring 9. Therefore, it is necessary to enhance the size precision of the A and B, as well as C and D and strict production management is required to maintain the precision, which further increases the costs of the wire connecting connector 2.

### SUMMARY OF THE INVENTION

In view of the above circumstances, it is an object of the present invention to provide a wire connecting connector in which a fitting load of the wire connecting connector is reduced to facilitate the connecting operation; a water resistance structure is simplified; and a size precision required to ensure the contacting performance between terminals is moderated, thereby reducing the production costs of the wire connecting connector.

To achieve the above object, a first aspect of the present invention provides a wire connecting connector comprising a receptor having one terminal exposed from a bottom thereof, and an inserting body having another terminal which is exposed from a tip end of the inserting body and which establishes an electrical connection with the one terminal when the inserting body is fitted into the receptor, wherein a conductive first viscoelastic agent is charged into the receptor so as to bury the one terminal, and an insulative second viscoelastic agent is overlaid on an outer side of the first viscoelastic agent.

According to this wire connecting connector, when the inserting body is fitted into the receptor, the tip end of the inserting body passes through the insulative second viscoelastic agent laminated on the outer side of the first viscoelastic agent and then the tip end is inserted into the conductive first viscoelastic agent charged into the bottom of the receptor. As a result, the one terminal exposed from the bottom of the receptor and the other terminal exposed from the tip end of the inserting body establish an electrical connection through the first viscoelastic agent, and thus, the other terminal need not always come into contact with the one terminal, thereby moderating a size precision when the inserting body is fitted into the receptor.

Furthermore, the inserting force of the inserting body can be as small as such a degree that the inserting body can pass through the second and first viscoelastic agents. In a state in which the one and the other terminals are inserted into the first viscoelastic agent, both the terminals are liquid tightly protected by the second viscoelastic agent that is overlaid on the outer side of the first viscoelastic agent. Therefore, waterproof function can be achieved with such a simple structure in which the second viscoelastic agent is overlaid. In addition, a conductive part of the first viscoelastic agent can be electrically protected by the second viscoelastic agent.

According to another aspect of the present invention, there is provided a wire connecting connector comprising a receptor having one terminal comprising a plurality of first contacts, the one terminal being exposed from a bottom of the receptor, and an inserting body having another terminal comprising a plurality of second contacts corresponding to the first contacts, the another terminal being exposed from a tip end of the inserting body and the first and second contacts establishing an electrical connection when the inserting body is fitted into the receptor, wherein a partition wall is provided in the receptor for isolating the first contacts from each other, and a groove is formed in a tip end of the inserting body, the groove dividing the second contacts from each other, and the groove being capable of receiving the partition wall, wherein a conductive first viscoelastic agent is charged into the receptor partitioned by the partition wall so as to bury the first contacts, and an insulative second viscoelastic agent is overlaid on an outer side of the first viscoelastic agent.

According to this wire connecting connector, the one terminal comprises the plurality of first contacts, and the other terminal comprises the plurality of second contacts corresponding to the first contacts. The first contacts provided in the receptor are isolated from each other by the partition wall and buried by the conductive first viscoelastic agent, and the outer side of the first viscoelastic agent is protected by the insulative second viscoelastic agent.

On the other hand, the inserting body is formed with the groove into which the partition wall can be inserted. Therefore, the inserting body can be fitted into the receptor, and in this fitted state where the first and second contacts are isolated from each other by the partition wall, the corresponding contacts can establish the electrical connection through the first viscoelastic agent. As a result, the same function as that of the wire connecting connector of the first aspect can certainly be obtained, and a plurality of electrodes, for example, positive and negative two electrodes or a multi-electrode such as three phase or six phase can also be connected by one wire connecting connector.

According to still another aspect of the present invention, disengagement prevention means is provided between the receptor and the inserting body for maintaining a fitted state therebetween.

According to this wire connecting connector, since the disengagement prevention means is provided between the receptor and the inserting body for maintaining a fitted state therebetween, the electrical connection between the one terminal and the other terminal is stably maintained.

### BRIEF DESCRIPTION OF THE DRAWINGS

FIG. 1 is a sectional view of an ignition coil of a proposed connector;

FIG. 2 is a sectional view of male connector of the proposed connector;

FIG. 3 is a sectional view of female connector of the proposed connector;

FIG. 4 is a perspective view of separated female connector and male connector showing one embodiment of a connector according to the present invention;

FIG. 5 is a vertical sectional view of the separated female connector and the male connector showing one embodiment of the invention;

FIG. 6 is a sectional view taken along a line VI-VI in FIG. 5 showing one embodiment of the connector of the invention; and

FIG. 7 is a vertical sectional view of the female connector and the male connector connected to each other showing one embodiment of the connector of the invention.

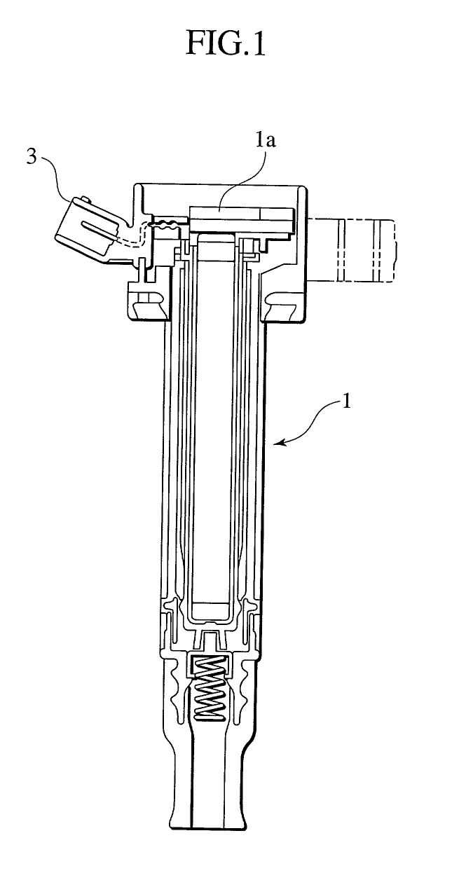

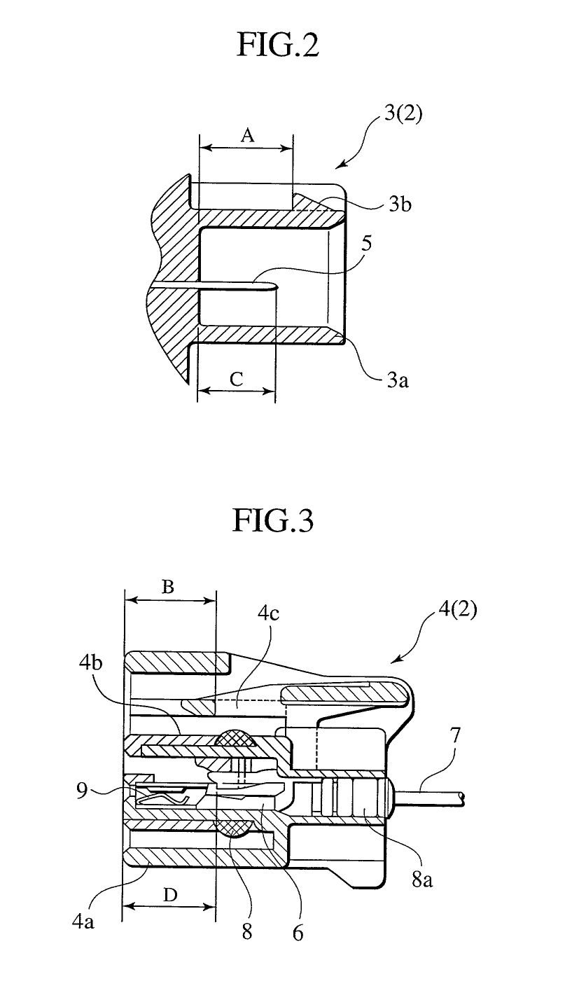

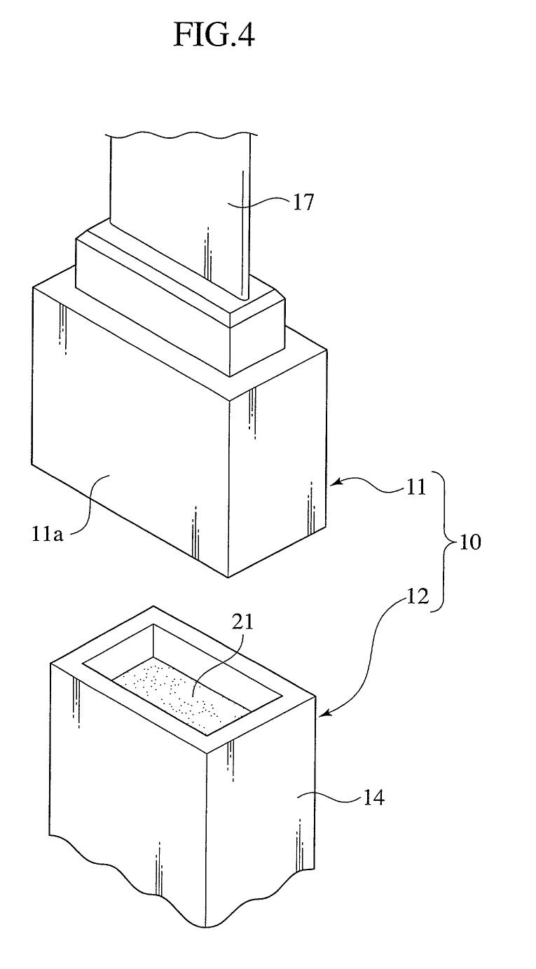

### DESCRIPTION OF THE PREFERRED EMBODIMENT

An embodiment of the present invention will be explained below in detail with reference to the accompanying drawings.

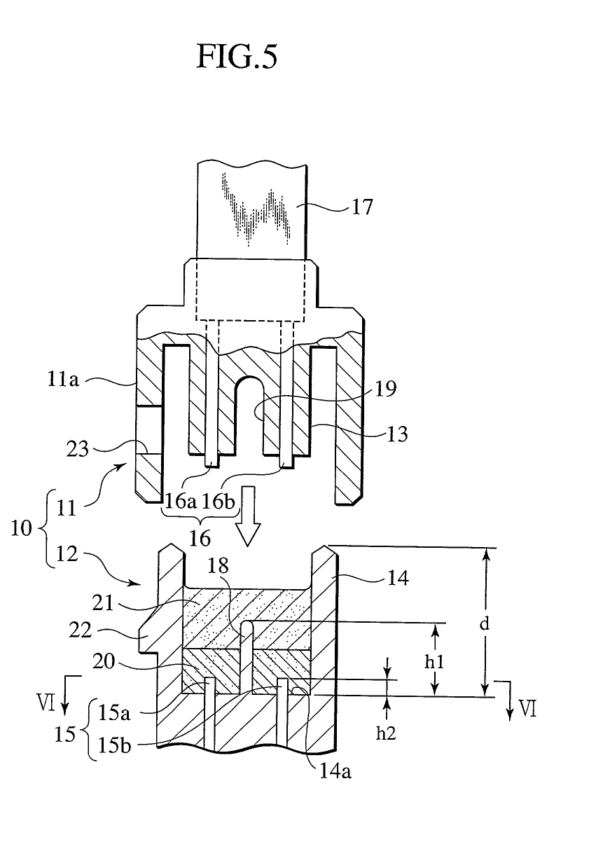

As shown in FIG. 4, a wire connecting connector 10 of the embodiment comprises a female connector 11 and a male connector 12. As shown in FIG. 5, the female connector 11 is provided with an outer peripheral wall 11a having a rectangular cross section. An inserting body 13 projects from a central portion in the outer peripheral wall 11a. On the other hand, the male connector 12 is provided with a receptor 14 having a rectangular cross section. The receptor 14 is fitted into the outer peripheral wall 11a of the female connector 11, and the inserting body 13 is fitted into the receptor 14.

A terminal having a pair of first contacts 15a and 15b which are positive and negative electrodes projects from a bottom 14a of the receptor 14. An appropriate distance is provided between the first contacts 15a and 15b. On the other hand, another terminal 16 comprising a pair of second contacts 16a and 16b respectively corresponding to the first contacts 15a and 15b projects from a tip end of the inserting body 13. In the present embodiment, a lower end (in FIG. 4) of the male connector 12 is integrally coupled to a housing of equipment (not shown), and the other terminal 16 of the female connector 11 is connected to an FFC (flexible flat cable) 17 extending upward in FIGS. 4, 5 and 7.

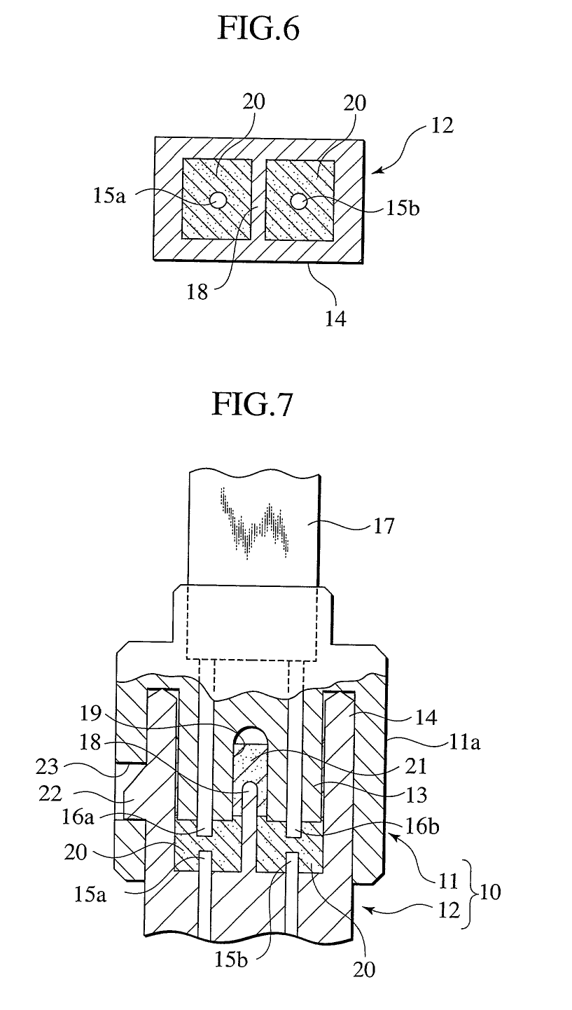

A partition wall 18 having a predetermined height h1 is disposed between the pair of first contacts 15a and 15b inside the receptor 14. The two first contacts 15a and 15b are isolated from each other by means of the partition wall 18 as shown in FIG. 6. The height h1 of the partition wall 18 is set higher than a projecting amount h2 of the first contacts 15a and 15b, and is set smaller than a depth d of the receptor 14.

A tip end of the inserting body 13 is formed with a groove 19. The second contacts 16a and 16b are divided from each other by this groove 19, and the partition wall 18 can be inserted into the groove 19. Therefore, when the inserting body 13 is fitted into the receptor 14, the second contacts 16a and 16b enter into the section isolated by the partition wall 18 while the partition wall 18 is inserted into the groove 19, and the corresponding first contact 15a and the second contact 16a, and the corresponding first contact 15b and the second contact 16b are opposed to each other at close positions.

In this embodiment, a conductive gel 20 as a conductive first viscoelastic agent is charged into the receptor 14 partitioned by the partition wall 18 so as to bury the first contacts 15a and 15b, and an insulative gel 21 as an insulative second viscoelastic agent is overlaid on the outer side of the conductive gel 20, i.e., an opening side of the receptor 14. A silicon gel to which conductive material is mixed is used as the conductive gel 20, and a silicon gel to which an insulative material is mixed is used as the insulative gel 21.

An engagement projection 22 projects from one of outer surfaces of the receptor 14 of the male connector 12, and an engagement hole 23 is formed at the outer peripheral wall 11a of the female connector 11 at its position corresponding to the engagement projection 22. The engagement projection 22 and the engagement hole 23 constitute a disengagement prevention means. If the engagement projection 22 engages into the engagement hole 23, the disengagement prevention means maintains the fitting state between the male connector 12 and the female connector Therefore, according to the wire connecting connector 10 of the present embodiment having the above structure, the wire connecting connector 10 is connected by inserting the female connector 11 into the male connector 12 as shown in FIG. 7, and at the same time the inserting body 13 is fitted into the receptor 14. At the time of the fitting operation, the partition wall 18 in the receptor 14 is inserted into the groove 19 of the inserting body 13, and the tip end of the inserting body 13 is inserted into the receptor 14 partitioned by the partition wall 18.

When the inserting body 13 is inserted into the receptor 14, the tip end of the inserting body 13 passes through the insulative gel 21 and then is inserted into the conductive gel 20. Since the conductive gel 20 is conductive, the first contacts 15a and 15b exposed to the bottom 14a of the receptor 14 and the corresponding second contacts 16a and 16b exposed from the tip end of the inserting body 13 establish the electrical connection through the conductive gel 20. At that time, the first contact 15a and the second contact 16a having the electrical connection, and the first contact 15b and the second contact 16b having the electrical connection are insulated from each other, and their electrical connection states are stably maintained by the engagement between the engagement projection 22 and the engagement hole 23.

As described above, according to the wire connecting connector 10 of the present embodiment, the first contacts 15a and 15b and the second contacts 16a and 16b establish the electrical connection through the conductive gel 20. Therefore, it is not always necessary that the corresponding contacts directly come into contact with each other as long as they are positioned in the conductive gel 20. Therefore, the size precision at the time when the inserting body 13 is fitted into the receptor 14 can be moderated. Furthermore, the inserting body 13 may only need an inserting force enough to pass through the insulative gel 21 and the conductive gel 20, and therefore, the fitting load can be reduced, thereby enhancing the connecting operability.

In a state where the first contacts 15a and 15b and the second contacts 16a and 16b establish the electrical connection in the conductive gel 20, the electrical connection portions are fluid tightly protected by the insulative gel 21 overlaid on the conductive gel 20. Accordingly, the water-proof function can be achieved with such a simple structure as the insulative gel 21 being overlaid on the conductive gel 20. Moreover, the conductive portion of the conductive gel 20 can be electrically protected by the insulative gel 21.

In the present embodiment, each of the one terminal 15 and the other terminal 16 has two poles constituted by the first contacts 15a and 15b and the second contacts 16a and 16b, respectively. Therefore, the two poles can be connected to each other by one wire connecting connector 10, and the connected portion of the harness can be made compact. Of course, the number of contacts may be one for each of the terminals 15 and 16, or the number of contacts may be set in correspondence with a multiple electrodes such as three phases or six phases. In this case, the contacts of the multiple electrodes are insulated from each other by means of a partition wall.

Although the cross section of each of the female connector 11 and the male connector 12 is rectangular in this embodiment, the present invention is not limited to this shape, and an arbitrary shape may be employed as long as terminals 15 and 16 can be positioned appropriately.

What is claimed is:

1. A wire connecting connector, comprising:
a receptor having one terminal exposed from a bottom thereof; and
an inserting body having another terminal which is exposed from a tip end of the inserting body and which establishes an electrical connection with the one terminal when the inserting body is fitted into the receptor;
wherein a conductive first viscoelastic agent is charged into the receptor so as to bury the one terminal, and an insulative second viscoelastic agent is overlaid on an outer side of the first viscoelastic agent.

2. A wire connecting connector, comprising:
a receptor having one terminal which includes a plurality of first contacts, the one terminal being exposed from a bottom of the receptor;
an inserting body having another terminal which includes a plurality of second contacts corresponding to the first contacts, the another terminal being exposed from a tip end of said inserting body and the first and second contacts establishing an electrical connection when the inserting body is fitted into the receptor;
a partition wall provided in the receptor for isolating the first contacts from each other; and
a groove formed in a tip end of the inserting body, the groove dividing the second contacts from each other, and the groove being capable of receiving the partition wall;
wherein a conductive first viscoelastic agent is charged into the receptor partitioned by the partition wall so as to bury the first contacts, and an insulative second viscoelastic agent is overlaid on an outer side of the first viscoelastic agent.

3. A wire connecting connector according to claim 1, wherein disengagement prevention means is provided between the receptor and the inserting body for maintaining a fitted state therebetween.

4. A wire connecting connector according to claim 2, wherein disengagement prevention means is provided between the receptor and the inserting body for maintaining a fitted state therebetween.

5. A wire connecting connector according to claim 3, wherein the disengagement prevention means comprises an engagement hole and an engagement projection.

6. A wire connecting connector according to claim 4, wherein the disengagement preventing means comprises an engagement hole and an engagement projection.
